(19) United States
(12) Patent Application Publication
(10) Pub. No.: US 2025/0271523 A1
(43) Pub. Date: Aug. 28, 2025

(54) ELECTRICALLY-POWERED TURBOMACHINE ASSEMBLIES

(71) Applicant: ZeroAvia, Inc., Hollister, CA (US)

(72) Inventors: Jonathan Leopold Nutzati Fontaine, Hollister, CA (US); Aleksey Petlenko, Hollister, CA (US)

(21) Appl. No.: 19/199,019

(22) Filed: May 5, 2025

Related U.S. Application Data
(62) Division of application No. 18/651,812, filed on May 1, 2024.
Application No. 18/651,812 is a continuation-in-part of application No. 18/458,787, filed on Aug. 30, 2023, now Pat. No. 12,000,404.

(51) Int. Cl. G01R 33/54; A61B 5/00; G01R 33/561

(52) U.S. Cl. CPC G01R 33/543; A61B 5/0044; G01R 33/561

(57) ABSTRACT

An electrically-powered turbine assembly includes a fixed housing; an air compressor including a compressor stator fixed to the housing; a turbine including a turbine stator fixed to the housing; a central shaft supported by the compressor stator and affixed to the turbine stator; an electric motor including an electric motor stator fixed to the central shaft, said electric motor having a rotating shell; an air compressor rotor affixed to the rotating electric motor shell; and a turbine rotor affixed to the rotating electric motor shell. The electrically-powered turbine assembly preferably includes one or more fuel cells as an electric power source. The electrically-powered turbine assembly may be used to power an aircraft.

### CROSS REFERENCE TO RELATED APPLICATIONS

This application is a Divisional Application of pending U.S. application Ser. No. 18/651,612, filed Apr. 30, 2024, which is a Continuation-in-Part (CIP) Application of U.S. application Ser. No. 18/458,787, filed Aug. 30, 2023, now U.S. Pat. No. 12,000,404, issued Jun. 4, 2024, the contents of which are incorporated herein in their entirety.

### TECHNICAL FIELD

The present disclosure relates to electrically-powered turbomachine assemblies and more particularly to hydrogen fuel cell electric engine systems for use with vehicles such as aircraft and will be described in connection with such utility, although other utilities are contemplated.

### BACKGROUND AND SUMMARY

This section provides background information related to the present disclosure which is not necessarily prior art. This section provides a general summary of the disclosure and is not a comprehensive disclosure of its full scope or all its features.

Exhaust emissions from transport vehicles are a significant contributor to climate change. Conventional fossil-fuel-powered aircraft engines release CO₂ emissions. Also, fossil-fuel-powered aircraft emissions include non-CO₂ effects due to nitrogen oxide (NOx), vapor trails, and cloud formation triggered by the altitude at which aircraft operate. These non-CO₂ effects are believed to contribute twice as much to global warming as aircraft CO₂ and are estimated to be responsible for two-thirds of aviation's climate impact. Additionally, the high-speed exhaust gasses of conventional fossil-fuel-powered aircraft engines contribute significantly to the extremely large noise footprint of commercial and military aircraft, particularly in densely populated areas.

Rechargeable battery-powered terrestrial vehicles, i.e., “EVs”, are slowly replacing conventional fossil-fuel-powered terrestrial vehicles. However, the weight and limited energy storage of batteries makes rechargeable battery-powered aircraft generally impractical.

Hydrogen fuel cells (FCs) offer an attractive alternative to fossil-fuel-burning engines. Hydrogen FC tanks may be quickly filled and store significant energy, and other than the relatively small amount of unreacted hydrogen gas, the reaction output exhausted from hydrogen FCs comprises essentially only water.

In our prior US Published Application No. US 2021/0151783 (hereinafter '783 application), we describe an integrated hydrogen FC-powered electric engine system that can be utilized, for example, in a turboprop or turbofan system, to provide a streamlined, light weight, power dense and efficient system. Referring to FIG. 1, the integrated hydrogen-FC-electric engine system 1 of our prior '783 application includes an elongated shaft 10 that defines a longitudinal axis “L” and extends through the entire powertrain of integrated hydrogen-FC-electric engine system 1 to function as a common shaft for the various components of the powertrain. Elongated shaft 10 supports propulsor 14 (e.g., a fan or propeller), a multi-stage air compressor system 12, 12a, 12b, a fuel pump 22 in fluid communication with a fuel source 20 (e.g., liquid hydrogen—LH₂), a heat exchanger 24 in fluid communication with air compressor system 12, 12a, 12b, a FC stack 26 in fluid communication with heat exchanger 24, and a motor assembly 30 disposed in electrical communication with inverter 29 and FC stack 26.

Air compressor system 12, 12a, 12b of integrated hydrogen-FC-electric engine system 1 includes an air inlet portion 12a at a distal end thereof and a compressor portion 12b that is disposed proximally of air inlet portion 12a for uninterrupted, axial delivery of airflow in the proximal direction. Compressor portion 12b supports a plurality of longitudinally spaced-apart rotatable compressor wheels 16 (e.g., multi-stage) that rotate in response to rotation of elongated shaft 10 for compressing air received through air inlet portion 12a for pushing the compressed air to a FC stack 26 for conversion to electrical energy. As can be appreciated, the number of compressor wheels/stages 16 and/or diameter, longitudinal spacing, and/or configuration thereof can be modified as desired to change the amount of air supply, and the higher the power, the bigger the propulsor 14. These compressor wheels 16 can be implemented as axial or centrifugal compressor stages. Further, the compressor can have one or more bypass valves and/or wastegates 17 to regulate the pressure and flow of the air that enters the downstream FC, as well as to manage the cold air supply to any auxiliary heat exchangers in the system.

Compressor 12b optionally can be mechanically coupled to elongated shaft 10 via a gearbox 18 to change (increase and/or decrease) compressor turbine rotations per minute (RPM) and to change airflow to FC stack 26. For instance, gearbox 18 can be configured to enable the airflow, or portions thereof, to be exhausted for controlling a rate of airflow through the FC stack 26, and thus, the output power.

Integrated hydrogen-FC-electric engine system 1 further includes a gas management system such as a heat exchanger 24 disposed concentrically about elongated shaft 10 and configured to control thermal and/or humidity characteristics of the compressed air from air compressor system 12 for conditioning the compressed air before entering FC stack 26. Integrated hydrogen-FC-electric engine system 1 further also includes a fuel source 20 of cryogenic fuel (e.g., liquid hydrogen—LH₂, or cold hydrogen gas) that is operatively coupled to heat exchanger 24 via a pump 22 configured to pump the fuel from fuel source 20 to heat exchanger 24 for conditioning. In particular, the LH₂ fuel, while in the heat exchanger 24, becomes gasified (e.g., LH₂ converts to hydrogen gas—H₂) due to heat absorbed from the compressed air. The hydrogen gas is then further heated in the heat exchanger 24 to a working temperature of the FCs 26 which also cools the compressed air to a working temperature of the FC 26. In one embodiment, a heater 39 can be coupled to or included with heat exchanger 24 to increase heat as necessary, for instance, when running under a low power regime. Integrated hydrogen-electric engine system 1 also may include one or more external radiator(s) 19 for facilitating airflow and adding, for instance, additional cooling. Additionally, and/or alternatively, motor assembly 30 can be coupled to heat exchanger 24 for looping in the cooling/heating loops from motor assembly 30 as necessary. Such heating/cooling control can be managed, for instance, via controller 200 of integrated hydrogen-electric engine system 1. In one embodiment, fuel source 20 can be disposed in fluid communication with motor assembly 30 or any other suitable component to facilitate cooling of such components. Motor assembly 30 can include any number of fuel cell modules 32 configured to march the power of the motors 30 and the inverters 29.

Pump 22 can be coaxially supported on elongated shaft 10 for actuation thereof in response to rotation of elongated shaft 10. Heat exchanger 24 is configured to cool the compressed air received from air compressor system 12, 12a, 12b with the assistance of the pumped liquid hydrogen.

While existing hydrogen fuel-cell-powered electric engine systems, such as those disclosed in our prior '783 application and as illustrated in FIG. 1 discussed above, advantageously may be mounted in the fuselage of an aircraft or a large nacelle mounted to an aircraft, such hydrogen FC-powered engine systems can be too large and awkwardly shaped for packaging in conventional aircraft wing nacelles. As a result, conventional hydrogen FC electric engine architectures do not provide sufficient power density (W/m³) to replace conventional fossil-fuel-powered turbine engines.

In our co-pending U.S. Application Ser. No. 63/532,871 filed Aug. 15, 2023 (Attorney Docket CI-ZERO 23.14-P US), the contents of which are incorporated herein by reference, we describe a compact hydrogen FC electric engine system comprising a centrifugal compressor and a turbine assembly rotatably mounted back-to-back on a common shaft, having one or more fuel cells mounted outside of the rotated mounted centrifugal compressor and rotatably mounted turbine assembly. The present disclosure provides electrically-powered turbomachine assemblies, and more particularly hydrogen FC electric systems having an even more compact architecture. Two additional embodiments are described in which the arrangement of rotor components of the compressor and the electric motors are nested within each other. A first embodiment comprising a so-called “inrunner” motor configured, where the motor rotor is on the inside of its stator, and a so-called “outrunner” configuration, where the motor rotor is on the outside of its stator.

More particularly, the subject disclosure according to one embodiment provides a compact electrically-powered turbomachine assembly in which an electric motor, an air compressor system, and a turbine system are arranged around a central rotating shaft, in a housing. The compressor stators and the turbine stators are affixed to the housing, and the electric motor stators are affixed to the compressor stators. The compressor blades and turbine blades, and the electric motor cores are all affixed to the rotating shaft, and the electric motors are located within the compressor system and the turbine system. One or more FCs and inverters are arranged to the exterior of the housing resulting in an extremely compact system that can be fitted into a conventional fossil-fuel-powered aircraft nacelle. This permits us to retrofit conventional fossil-fuel-powered aircraft, replacing the existing fossil-fuel-powered turbine engines with hydrogen FC electric engines.

In a second embodiment, the integrated hydrogen-electric turbomachine assembly includes a fixed central shaft. Along the shaft, fixed components include motor stators, turbo compressor stator vanes, and expansion turbine stator vanes. The turbo compressor stator vanes are supported by the housing. The motor stators are supported by the central shaft which is in turn supported by stator vanes. The stator vanes outer edges are connected to a tubular housing which acts as both mechanical support and an aerodynamic duct. Each motor has a rotating outer shell, or rotor. Mounted to the shell of the motor(s) are compressor or turbine blades. Each rotating shell is supported by one or more bearings, preferably two, to maintain the alignment of the rotating machinery relative to the fixed machinery. In one embodiment, the outer shell of the motor is the stator (fixed) and the inner portion rotates.

One purpose of the compressor is to pressurize and condition air for the FCs. Air in a plenum is fed into the FC cathode side inlet. FC exhaust may then be combusted in an anode tail oxidizer (ATO) to harvest additional enthalpy to drive the turbine. Excess enthalpy in the flow after the turbine can be used to generate thrust directly through a nozzle.

Electrical power is provided to the motors via stator vanes aligned with each motor. There may be electrical conduits within the stator vanes, or the entire blade may be made of an electrically conductive material. Different blades may be connected to the phase leads of the motors. Sensors such as phase encoders may be connected via wires in electrical conduits within the stator vanes. The wiring to the motor stator coils may also pass axially along the central shaft.

The FCs are cooled using ram air, which in some flight conditions is too cold to apply to the FCs directly and may require heating. In such case, warm bleed air from turbine may be injected into and mixed with the ram air stream using injectors. In other embodiments, the bleed air could also be pulled from the compressor. In some embodiments, the ram air is assisted by a fan, which offsets the pressure drop of the ducting and allows for the duct to cool when the engine is operating while the aircraft is stationary.

Fluids for cooling or lubrication may be piped in passages within the stator vanes. A passage may enclose a fluid flow tube, or the fluid passage may be a hole connecting the inner and outer ends of the stator vanes. The fluids may be oils for lubrication of motor or rotor bearings, coolants, hydraulic or pneumatic pressure transmission. The fluids may also pass axially along the central shaft.

Air moving through the compressor may be used to heat or cool fluids moving through stator vanes. This includes motor coolant and lubrication, as well as fuel cell coolant, pumped through the stator vanes. The internal structure of the stator vane can be designed to optimize the internal flow paths of fluids to maximize contact with the vane surface, acting as a heat exchanger. As an additional effect, fluid pumped through the stator vanes may be used to condition air flowing through the compressor before it reaches the fuel cell cathode. If cold fluid (e.g., turbine oil) is pumped through the stator vanes (e.g., to warm lubricant from a larger reservoir to achieve desired rheometric properties), it may be used to intercool (isobaric cooling) air as it moves through the compressor. Liquid hydrogen will need to be heated and may be pumped through stator vanes to absorb heat from the vanes and gasify the LH₂ before being introduced to the FC.

Passages within the central shaft may convey fluids from one location along the shaft to another. Seals and rotating couplings may enable multiple fluids to be conveyed to and from multiple locations. In particular, rotating seals may enable a coolant or lubricant to pass from the stationary central shaft to the rotating motor shells. In some cases, the fluids may be cryogenic coolants, including liquid hydrogen. This could enable superconducting motor windings. The turbine generator and compressor motors are electrically coupled, so that energy recovered from the turbine can be used to power the compressor. In one embodiment, electrical connections may be routed through the stationary central shaft.

In accordance with Aspect A of the present disclosure, we provide an electrically-powered turbomachine assembly comprising: a housing; a rotating shaft; an air compressor comprising one or more compressor stators; one or more electric motors including one or more electric motor stators and electric motor rotors.

In one embodiment of Aspect A, one or more fuel cells are radially arranged on an outside of the housing.

In one embodiment of Aspect A, the central shaft comprises a rotatable shaft, and the one or more compressors or rotors, the one or more turbine rotors, and the one or more electric motor rotors are fixed to rotate with the shaft.

In another embodiment of Aspect A one or more electric motor stators are fixed to and arranged on a non-rotating shaft, and compressor and turbine rotors are fixed to rotate with the electric motor rotors around the one or more electric motor stators.

In another embodiment of Aspect A, the electric motor core, the compressor rotor, and the turbine rotor are mechanically linked together via the rotating shaft.

In another embodiment of Aspect A, one or more of the one or more compressor stators and/or the one or more electric motor stators and/or the one or more turbine stators is/are configured for carrying an electric current.

In one embodiment of Aspect A, one or more of the compressor stators and/or the one or more of the turbine stators and/or one or more of the electric motor stators has/have a passage or passages configured to accommodate an electrical conduit within the stator. In another embodiment one or more of the compressor stators and/or one or more of the turbine stators preferably is/are formed of an electrically conductive material and is configured to carry an electrical current.

In another embodiment of Aspect A, one or more of the compressor stators and/or one or more of the turbine stators and/or one or more of the electric motor stators has/have a passage or passages configured to carry a fluid. In such an embodiment the fluid may comprise a thermal transfer fluid, or a lubricant. In such an embodiment, the one or more stators may include internal fluidics channels configured to optimize heat transfer. In the case where the fluid is a lubricant, in one embodiment the lubricant may form a fluid dynamic bearing for supporting the rotating shaft.

In another embodiment of Aspect A, one or more of the motor stators include cooling fins.

In a further embodiment, the rotating shaft comprises a segmented shaft, wherein the shaft segments are mechanically coupled to one another.

In another embodiment, one or more electric motors are also configured to act as electrical generators.

In still yet another embodiment, the air compressor and the turbine respectively include one or more counter-rotating rotors.

In a further embodiment, the fixed central shaft is configured as a conduit for fluid transfer and/or electrical power.

In another embodiment, the one or more compressor stators are configured for carrying an electric current, and have a passage configured to accommodate an electrical conduit within the one or more stators or are formed of an electrically conductive material configured to carry an electrical current.

In yet another embodiment, the one or more compressor stators have a passage configured to carry a fluid, wherein the fluid optionally comprises a thermal transfer fluid for cooling the one or more motor stators and/or for cooling air as the air is moved through the air compressor, and optionally wherein the one or more compressor stators include internal fluidics channels configured to optimize heat exchange.

In still yet another embodiment, the one or more fuel cells comprise hydrogen fuel cells and the fluid comprises hydrogen and further wherein the hydrogen flowing through the conduit optionally is in liquid form and is configured to receive heat from the assembly to change from liquid form to gas form for use by one or more fuel cells.

In a further embodiment, the fluid acts as a lubricant, or as a fluid dynamic bearing.

In another embodiment, the central shaft comprises a segmented shaft, wherein the shaft segments are mechanically coupled to one another.

In yet another embodiment, one or more fuel cells are arranged radially on an outside of the housing, and wherein an output from the compressor optionally is coupled to an intake of the one or more fuel cells cathodes, wherein an exhaust from the one or more fuel cells optionally is coupled to an anode tail oxidizer, and wherein an inlet manifold for the turbine optionally is configured to contain a catalytic mesh for the anode tail oxidizer.

In still yet another embodiment, the fixed housing includes an annular manifold having an inlet configured to capture a flow of air from the air compressor, and wherein the annular manifold optionally has an outlet configured to deliver air to a cathode side of the one or more fuel cells.

In a further embodiment, an anode exhaust from the one or more fuel cells is passed to the turbine.

In another embodiment, one or more electric motors include fins configured to be cooled by airflow from the compressor.

In yet another embodiment, one or more inverters electrically connected to the electric motor, wherein the one or more inverters include cooling fins extending into the housing and into the cooling airflow from the compressor.

According to Aspect B, the present disclosure provides a FC-powered vehicle comprising the electrically-powered turbomachine assembly as above described to provide thrust, electrical power and/or reactant cooling.

In one embodiment of Aspect B, one or more FCs and/or current inverters arranged outside of the electrically-powered turbine assembly.

In one embodiment of Aspect B, the air compressors are configured to deliver air to a cathode side of one or more FCs.

In another embodiment of Aspect B, anode exhaust from the FCs is passed to the turbine.

In a further embodiment of Aspect B, the electric motor stators include fins configured to be cooled by airflow from the compressor.

In yet another embodiment of Aspect B, the system includes one or more inverters having cooling fins configured to extend into the housing and into cooling airflow from the compressor.

In a particularly preferred embodiment of Aspect B, the vehicle is an aircraft.

According to Aspect C there is provided an electrically-powered turbomachine assembly comprising: a fixed housing; an air compressor including an air compressor rotor, and one or more compressor stator fixed to the housing; a turbine including a turbine rotor, and one or more turbine stators fixed to the housing; a central shaft supported by the one or more compressor stators and the one or more turbine stators; an electric motor including an electric motor stator and an electric motor rotor; and two or more FCs radially arranged on an outside of the housing.

In one embodiment of Aspect C, the central shaft comprises a rotatable shaft, and the compressor rotor, and the turbine rotor are fixed to rotate with the shaft.

In another embodiment of Aspect C, one or more electric motor stators are fixed to rotate with the compressor rotor, and the turbine rotor is fixed to rotate with the electric motor rotor.

In another embodiment of Aspect C, the compressor stator is configured for carrying an electric current. In such an embodiment, the compressor stator may be a passage configured to accommodate an electrical conduit within the stator. Alternatively, the compressor stator may be formed of an electrically conductive material and is configured to carry an electrical current.

In a further embodiment of Aspect C the compressor stator has a passage configured to carry a fluid. In such an embodiment, the fluid may comprise a thermal transfer fluid for cooling the one or more motor stators and/or for cooling air as the air is moved through the air compressor. Alternatively, the fluid may comprise hydrogen. In yet another embodiment the fluid may comprise a lubricant. In yet another embodiment, the fluid may form a fluid dynamic bearing.

In a further embodiment of Aspect C, the central shaft comprises a segmented shaft, wherein the shaft segments are mechanically coupled to one another.

In another embodiment of Aspect C, wherein one or more FCs are arranged around an outside of the fixed housing, the fixed housing includes an annular manifold having an inlet configured to capture a flow of air from the air compressor. In such embodiment, the annular manifold preferably includes an outlet configured to deliver air to a cathode side of the one or more fuel cells, and an anode exhaust from the one or more FCs is passed to the turbine.

In a further embodiment of Aspect C, the electric motor includes fins configured to be cooled by airflow from the compressor.

In another embodiment of Aspect C, one or more inverters electrically connected to the electric motor are included, wherein the one or more inverters include cooling fins extending into the housing and into the airflow from the compressor.

According to Aspect D there is provided an electrically-powered turbomachine assembly comprising: a fixed housing; an air compressor including one or more compressor rotors, and one or more compressor stators, where one or more of the compressor stators are fixed to the housing; a turbine including one or more turbine rotors, and one or more turbine stators, where one or more of the turbine stators are fixed to the housing; a central shaft supported at least in part by the one or more compressor stators and the one or more turbine stators; and one or more electric motors including electric motor stators and electric motor rotors, wherein the one or more electric motor stators are fixed to and arranged on a non-rotating shaft, and the air compressor and the turbine rotors are fixed to rotate with the electric motor rotors around the one or more electric motor stators.

In one embodiment of Aspect D, the electrically-powered turbomachine assembly further comprises one or more fuel cells arranged on an outside of the housing.

In another embodiment of Aspect D, the one or more electric motors are also configured to act as electrical generators.

In a further embodiment of Aspect D, the air compressor and the turbine respectively include one or more counter-rotating rotors.

In yet another embodiment of Aspect D, the compressor rotors and the turbine rotors are configured independently change rotation direction or rotation speed.

In still another embodiment of Aspect D, one or more of the compressors are configured to function as turbines or one or more of the turbines are configured to function as compressors.

In another embodiment of Aspect D, the central shaft does not include compressor stators or turbine stators.

In a further embodiment of Aspect D, the non-rotating shaft is configured as a conduit for fluid transfer and/or electrical power.

In another embodiment of Aspect D, the one or more compressor stators are configured for carrying an electric current, and have a passage configured to accommodate an electrical conduit within the one or more stators, or are formed of an electrically conductive material configured to carry an electrical current.

In yet another embodiment of Aspect D, the one or more compressor stators have a passage configured to carry a fluid, wherein the fluid optionally comprises a thermal transfer fluid for cooling the one or more motor stators and/or for cooling air as the air is moved through the air compressor, and optionally wherein the one or more compressor stators include internal fluidics channels configured to optimize heat exchange.

In still another embodiment of Aspect D, the one or more fuel cells comprise hydrogen fuel cells and the fluid comprises hydrogen and further wherein the shaft is configured to convey hydrogen in liquid form from one location along the shaft to another location and is configured to receive heat from the assembly to change the hydrogen from liquid form to gas form for use by one or more fuel cells.

In a further embodiment of Aspect D, the central shaft comprises a segmented shaft, wherein the shaft segments are mechanically coupled to one another.

In a further embodiment of Aspect D, one or more fuel cells are arranged radially on an outside of the housing, and wherein an output from the compressor optionally is coupled to an intake of the one or more fuel cells cathodes, wherein an exhaust from the one or more fuel cells optionally is coupled to an anode tail oxidizer, and wherein an inlet manifold for the turbine optionally is configured to contain a catalytic mesh for the anode tail oxidizer.

In a further embodiment of Aspect D, the fixed housing includes an annular manifold having an inlet configured to capture a flow of air from the air compressor, and wherein the annular manifold optionally has an outlet configured to deliver air to a cathode side of the one or more fuel cells.

In still another embodiment of Aspect D, an anode exhaust from the one or more fuel cells is passed to the turbine.

In yet another embodiment of Aspect D, the one or more electric motors include fins configured to be cooled by airflow from the compressor.

According to Aspect E of the disclosure, there is provided a vehicle powered by an electrically powered turbomachine assembly as above described.

In one embodiment of Aspect E, the electrically powered turbomachine assembly includes one or more fuel cells as an electrical power source.

In another embodiment of Aspect E, the vehicle comprises an airplane.

Further areas of applicability will become apparent from the description provided herein. The description and specific examples in this summary are intended for purposes of illustration only and are not intended to limit the scope of the present disclosure.

### BRIEF DESCRIPTION OF THE DRAWINGS

Further features and advantages of the disclosure will be seen in the following detailed description, taken in conjunction with the accompanying drawings, wherein like numerals depict like parts. The drawings described herein are for illustrative purposes only of selected embodiments and not all possible implementations and are not intended to limit the scope of the present disclosure.

In the drawings:

FIG. 1 is a schematic view of an integrated hydrogen-electric engine system in accordance with the prior art;

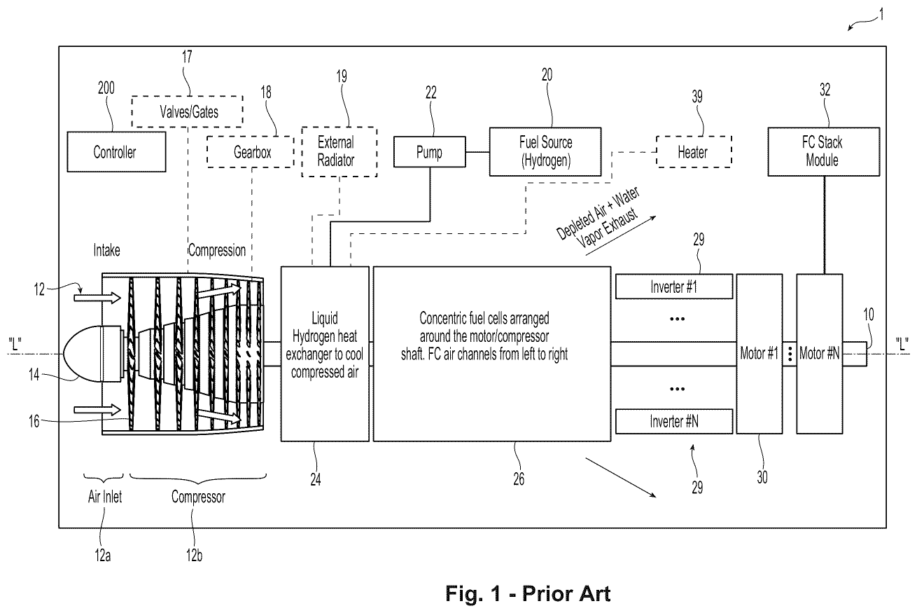

FIG. 2 is a schematic view of an integrated hydrogen-electric turbomachine assembly in accordance with one embodiment of the present disclosure;

FIG. 3 is a perspective view, in cross-section of an integrated hydrogen-electric turbomachine assembly in accordance with a second embodiment of the present disclosure;

FIG. 4 is a schematic view of the integrated hydrogen FC electric turbomachine assembly of FIG. 3;

FIG. 5 is a schematic diagram showing the third alternative embodiment of an integrated hydrogen FC electric turbomachine assembly in accordance with the present disclosure;

FIG. 6 is a schematic diagram of the integrated hydrogen FC electric turbomachine assembly of FIG. 5, and showing airflow, electrical and fluid transfer through the system; and

FIG. 7 is a schematic view of an aircraft incorporating a pair of hydrogen FC electric turbomachine assembly in accordance with the present disclosure.

### DETAILED DESCRIPTION

Example embodiments will now be described more fully with reference to the accompanying drawings. Example embodiments are provided so that this disclosure will be thorough and will fully convey the scope to those who are skilled in the art. Numerous specific details are set forth, such as examples of specific components, devices, and methods to provide a thorough understanding of embodiments of the present disclosure. It will be apparent to those skilled in the art that specific details need not be employed, that example embodiments may be embodied in many different forms, and that neither should be construed to limit the scope of the disclosure. In some example embodiments, well-known processes, well-known device structures, and well-known technologies are not described in detail.

The terminology used herein is for the purpose of describing particular example embodiments only and is not intended to be limiting. As used herein, the singular forms “a,” “an,” and “the” may be intended to include the plural forms as well, unless the context clearly indicates otherwise. The terms “comprises,” “comprising,” “including,” and “having” are inclusive and therefore specify the presence of stated features, integers, steps, operations, elements, components, and/or groups, but do not preclude the presence or addition of one or more other features, integers, steps, operations, elements, components, and/or groups thereof. The method steps, processes, and operations described herein are not to be construed as necessarily requiring their performance in the particular order discussed or illustrated, unless specifically identified as an order of performance. It is also to be understood that additional or alternative steps may be employed.

When an element or layer is referred to as being “on,” “engaged to,” “connected to,” or “coupled to” another element or layer, it may be directly on, engaged, connected, or coupled to the other element or layer, or intervening elements or layers may be present. In contrast, when an element is referred to as being “directly on,” “directly engaged to,” “directly connected to,” or “directly coupled to” another element or layer, there may be no intervening elements or layers present. Other words used to describe the relationship between elements should be interpreted in a like fashion (e.g., “between” versus “directly between,” “adjacent” versus “directly adjacent,” etc.). As used herein, the term “and/or” includes any and all combinations of one or more of the associated listed items.

Although the terms first, second, third, etc. may be used herein to describe various elements, components, regions, layers, and/or sections, these elements, components, regions, layers, and/or sections should not be limited by these terms. These terms may be only used to distinguish one element, component, region, layer, or section from another element, component region, layer, or section. Terms such as “first,” “second,” and other numerical terms when used herein do not imply a sequence or order unless clearly indicated by the context. Thus, a first element, component, region, layer, or section discussed below could be termed a second element, component, region, layer, or section without departing from the teachings of the example embodiments.

Spatially relative terms, such as “inner,” “outer,” “beneath,” “below,” “lower,” “above,” “upper,” and the like, may be used herein for ease of description to describe one element or feature's relationship to another element(s) or feature(s) as illustrated in the figures. Spatially relative terms may be intended to encompass different orientations of the device in use or operation in addition to the orientation depicted in the figures. For example, if the device in the figures is turned over, elements described as “below”, or “beneath” other elements or features would then be oriented “above” the other elements or features. Thus, the example term “below” can encompass both an orientation of above and below. The device may be otherwise oriented (rotated 90 degrees or at other orientations) and the spatially relative descriptors used herein interpreted accordingly.

As used herein “turbomachine assembly” is intended to refer both to compressors and turbines.

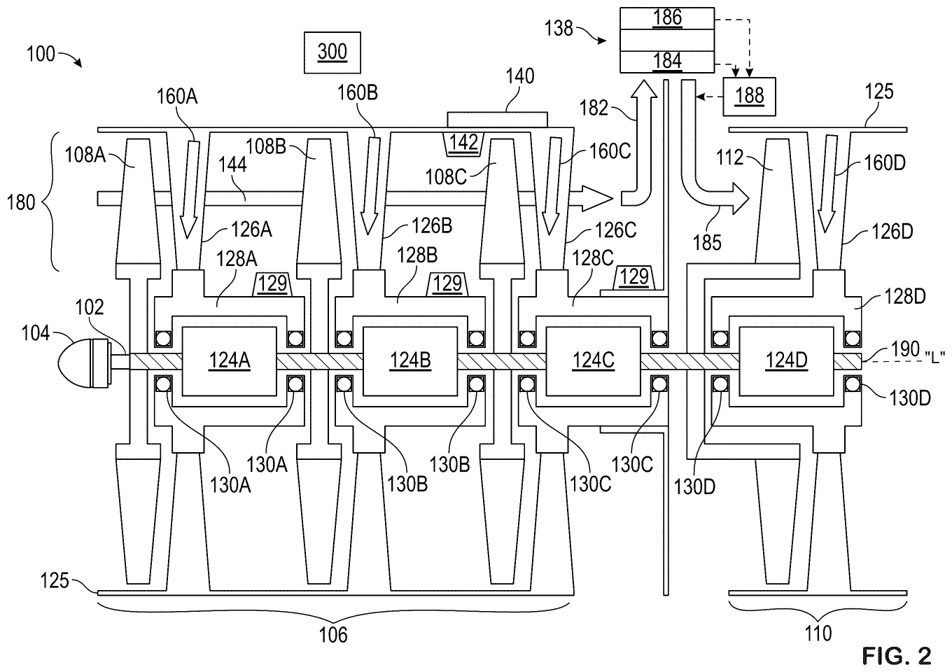

FIG. 2 illustrates an integrated hydrogen-electric turbomachine assembly 100 that can be utilized, for example, in a turboprop or turbofan system in accordance with the present disclosure. Integrated hydrogen-electric turbomachine assembly 100 includes a shaft 102 that defines a longitudinal axis “L” and extends through the entire powertrain of integrated hydrogen-electric turbomachine assembly 100 to function as a common shaft for the various components of the powertrain. Elongated shaft 102 supports a propulsor 104 (e.g., a fan or propellor) and a multi-stage air compressor section 106 comprising a plurality of compressor rotors 108A, 108B, 108C and a turbine section 110 comprising a turbine rotor 112. Compressor rotors 108A, 108B, 108C and turbine rotor 112 are fixed to rotating shaft 102. A plurality of electric motor cores 124A, 124B, 124C are also rotatably fixed to rotating shaft 102 within the multi-stage air compressor section 106, and an electric motor core 124D is fixed to rotating shaft 102 in turbine section 110. The air compressor motor housings 128A, 128B, 128C are supportably fixed to housing 125 on air compressor stators 126A, 126B, 126C. The turbine motor housing 128D is supportably fixed to housing 125 on turbine stator 126D. Electric motor housings 128A, 128B, 128C are affixed to air compressor stators 126A, 126B, 126C, and electric motor housing 128D is affixed to turbine stator 126D which in turn is fixed to housing 125. The electric motor identified by housing 128D may also act as an electric generator when power is supplied by the turbine to rotate the motor. The electric motor attached to the turbine also can act as a generator when rotated by the turbine when excess enthalpy is harvested by the turbine. Electric motor housings 128A, 128B, 128C and 128D also form the stators for the electric motors. Shaft 102 is rotatably supported within compressor stators 126A, 126B, 126C and turbine stator 126D on bearing pairs 130A, 130B, 130C, 130D, respectively.

Compressor stators 126A, 126B, 126C, and turbine stator 126D include internal passages 160A, 160B, 160C, 160D for carrying coolant air to and from the electric motor cores 124A, 124B, 124C, 124D. Internal passages 160A, 160B, 160C, 160D also may be configured to deliver lubricant to bearings 130A, 130B, 130C, 130D. Compressor stators 126A, 126B, 126C and turbine stator 126D also may be configured for accommodating electrical wiring for carrying electricity generated by the FCs 138 (only one of which is shown, and not to scale) to power the electric motors. Alternatively, compressor or turbine stators 126A, 126B, 126C, 126D may be formed of electrically conductive materials for carrying electric current to the electric motors.

The integrated hydrogen-electric turbomachine assembly 100 also includes inverter(s) 140 located immediately to the outside of housing 125 with the shortest path to each motor. Inverter(s) 140 may include cooling fin(s) 142 extending into housing 125 in contact with the compressor airflow 144. In similar manner, the electric motor stators 128A, 128B, 128C may include cooling fin(s) 129, and the compressor airflow also may be used to cool the electric motors. Inverter(s) 140 are configured to convert direct current from the FCs 138 to alternating current for actuating one or more electric motor(s) in electrical communication with inverter(s) 140. The one or more electric motor(s) drives elongated shaft 102 which carries the compressor rotors 108A, 108B, 108C and propulsor 104.

In operation, compressor airflow 144 is introduced into air inlet 180 and compressed by the air compressor section 106 and passed via high pressure air outlet 182 to the cathode side 184 of FC 138 where the oxygen in the air is reacted with hydrogen to produce electricity and reaction exhaust comprising primarily hot air and hot water. The water is separated, and the hot air exhaust from the FC 138 is passed via turbine inlet 185 to turbine section 110 where it is used for driving the one or more turbine rotors 112. Optionally, the hydrogen exhaust from the FC anode 186 can be combined with the exhaust from the FC cathode 184 and combusted in an anode tail oxidizer (ATO) 188 before returning to the turbine inlet 185.

Integrated hydrogen-electric turbomachine assembly 100 further includes a controller 300 for controlling the various aspects of the integrated hydrogen-electric turbomachine assembly 100 and/or other components of the aircraft system. For example, controller 300 can be configured to manage a flow of liquid hydrogen, manage coolant liquids and rates of hydrogen and air going into the system and/or flows of hydrogen fuel and air to the FCs.

Alternatively, fluids for cooling the electric motors and fluids for lubricating the shaft bearings may be piped in passages 160A, 160B, 160C, 160D within the compressor stators 126A, 126B, 126C and the turbine stator 126D. The passages may enclose fluid flow tubes, or the passages may be hollow passages connecting the inner and outer ends of the stators. We also can include sensors and phase encoders (not shown) within the motor stators. Also, different stators may be connected to different phase leads of the electric motors.

The rotating shaft 102 may comprise a unitary shaft or segmented shaft in which the segments are mechanically connected together by splines, couplings, gears and/or clutches. Shaft(s) 102 also may be provided with passage(s) 190 for conveying fluids from one location along shaft to another. Seals and rotating couplings (not shown) can enable multiple fluids to be conveyed to and from multiple locations within the integrated hydrogen-electric engine system.

In one embodiment, the shaft 102 may be configured to carry cryogenic fluids, including, for example, liquid hydrogen from the fuel store, to the electric motors. This would enable us to employ superconducting motor windings.

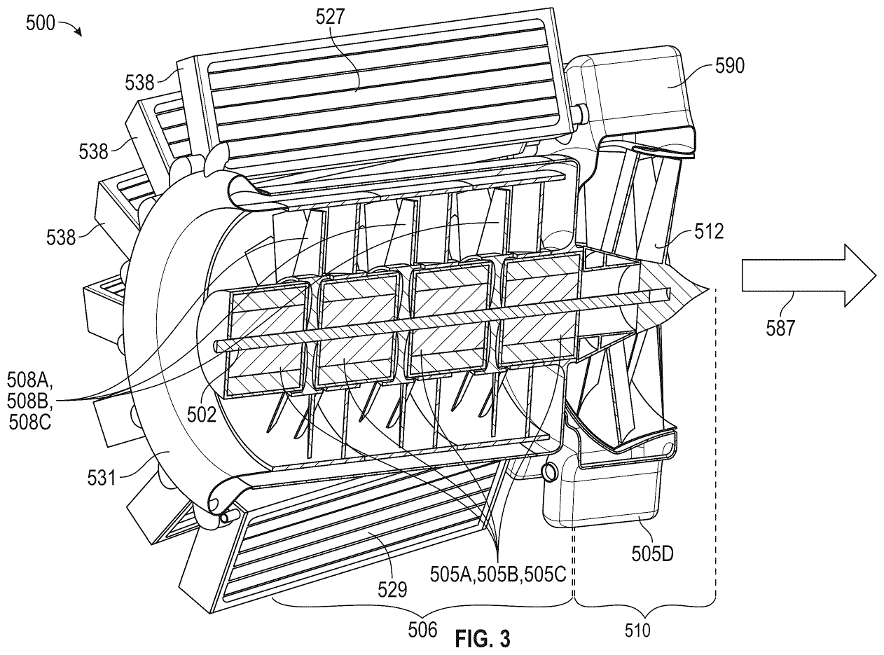

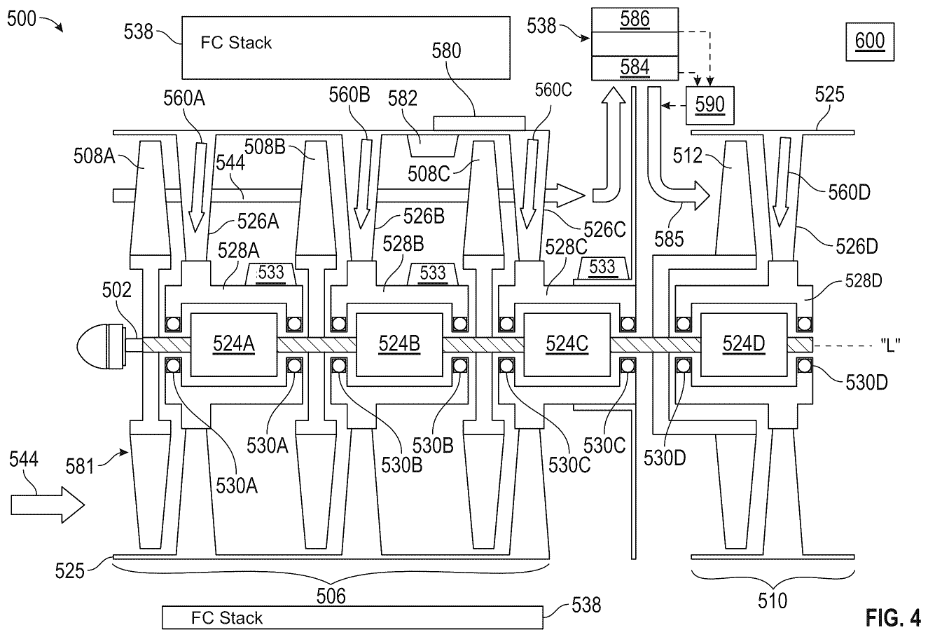

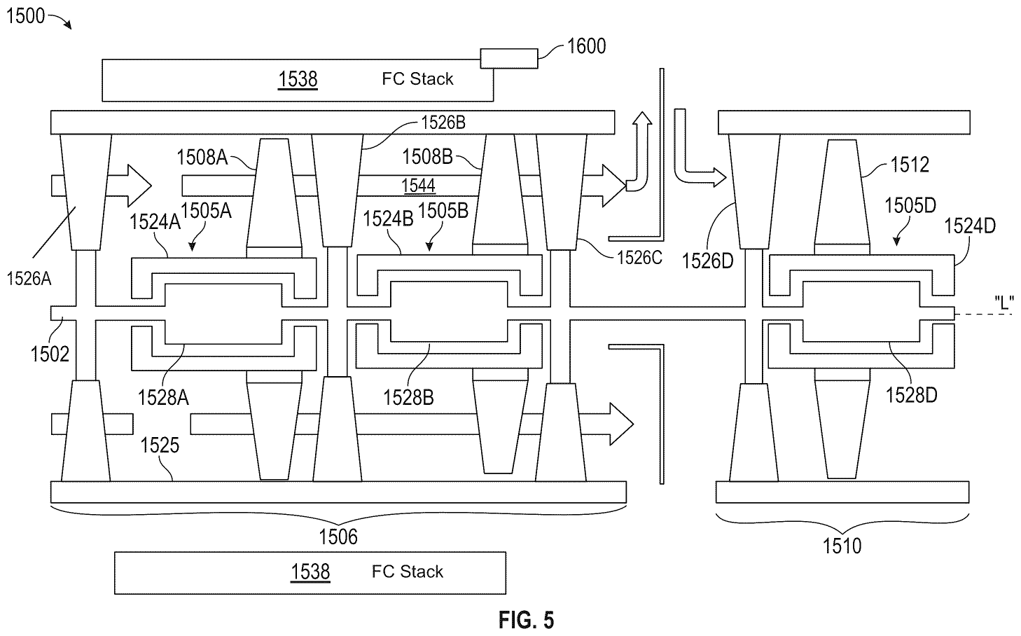

In other embodiments, FCs are positioned at radial locations on the outside of a central duct of the integrated hydrogen-electric engine system where a compressor (axial or centrifugal) is driven by motors and a turbine is fixed along a central shaft. Two such other embodiments are envisioned: an inrunner motor configuration where the motor rotor is on the inside (FIGS. 3 and 4), as will be described below in detail, and an outrunner configuration where the motor rotor is on the outside (FIGS. 5-7), as will be described below in detail.

FIGS. 3 and 4 illustrate a second embodiment of an integrated hydrogen-electric turbomachine assembly 500 that can be utilized, for example, in a turboprop or turbofan system in accordance with the present disclosure. For the sake of illustration, non-electrical common elements such as the propulsor have been omitted. Integrated hydrogen-electric turbomachine assembly 500 includes an elongated shaft 502 that defines a longitudinal axis “L” (shown in FIG. 4) and extends through the entire powertrain of integrated hydrogen-electric turbomachine assembly 500 to function as a common shaft for the various components of the powertrain. Elongated shaft 502 supports a propulsor (e.g., a fan or propellor) (not shown), a plurality of electric motors 505A, 505B, 505C within a multi-stage air compressor section 506 which includes a plurality of compressor rotors 508A, 508B, 508C, and a turbine rotor 505D within a turbine section 510. Shaft 502 is rotatably supported on compressor stators 526A, 526B, 526C and turbine stator 526D. Each electric motor 505A, 505B, 505C, 505D includes a motor core 524A, 524B, 524C, 524D, and a motor housing including a stator 526A, 5262B, 526C, 526D. Compressor rotors 508A, 508B, 508C and turbine rotor 505D are fixed to shaft 502.

Shaft 502 is rotatably supported within compressor stators 526A, 526B, 526C and turbine stator 526D on bearing pairs 530A, 530B, 530C, 530D.

As in the case of the FIG. 2 embodiment, compressor stators 526A, 526B, 526C, and turbine stator 526D include internal passages 560A, 560B, 560C, 560D for carrying coolant air to and from the electric motors 505A, 505B, 505C, 505D. The internal passages also may be configured to deliver lubricant to bearings (not shown). Compressor stators 526A, 526B, 526C and turbine stator 526D also may be configured for accommodating electrical wiring for carrying electricity generated by FC stacks 538 which are radially mounted on the exterior of housing 525 which acts both as a mechanical support and an aerodynamic duct. Alternatively, compressor or turbine stators 526A, 526B, 526C, 526D may be formed of electrically conductive materials for carrying electric current to the electric motors.

FC stacks 538 include heat exchanger inlet faces 527 and heat exchanger outlet faces 529. An annular cathode manifold plenum 531 is provided and is configured to deliver compressed air from the air compressor section 506 to the inlet faces of the FC stacks 538.

Also, as in the case of the FIG. 2 embodiment, the integrated hydrogen-electric turbomachine assembly 500 also includes inverter 580 located immediately to the outside of housing 525 with the shortest path to each motor. The inverter(s) may include cooling fins 582 extending into housing 525 in contact with the compressor airflow 544. In similar manner as the FIG. 2 embodiment, the electric motor housings 528A, 528B, 528C may include cooling fins 533, and the compressor airflow also may be used to cool the electric motors. Electric motor housing 528D is affixed to turbine stator 526D The inverter(s) are configured to convert direct current from the FC stacks 538 to alternating current for actuating the one or more electric motor(s) in electrical communication with inverter(s). The one or more electric motor(s) 505A, 505B, 505C, 505D drives elongated shaft 502 which carries the compressor rotors 508A, 508B, 508C and propulsor (not shown).

In operation, air 544 is introduced into air inlet 581 and compressed by the air compressor section 506 and passed via annular cathode manifold plenum 531 to the cathode side 584 of FC stack 538 where the oxygen in the air is reacted with hydrogen to produce electricity and reaction exhaust comprising primarily hot air and hot water. The water is separated, and the hot air exhaust from the FC stack 538 is passed via turbine inlet 585 to the turbine section 510 where it is used for driving the one or more turbine rotors 512. Optionally, the hydrogen exhaust from the FC anode 586 can be combined with the exhaust from the FC cathode 584 and combusted in an anode tail oxidizer 590, to harvest additional enthalpy to drive the turbine. Excess enthalpy in the flow after the turbine can be used to generate thrust direct through a nozzle 587.

Integrated hydrogen-electric turbomachine assembly 500 further includes a controller 600 for controlling the various aspects of the integrated hydrogen-electric turbomachine assembly 500 and/or other components of the aircraft system. For example, controller 600 can be configured to manage a flow of liquid hydrogen, and coolant liquids, rates of hydrogen and air going into the system, and/or flows of hydrogen fuel and air to the FCs.

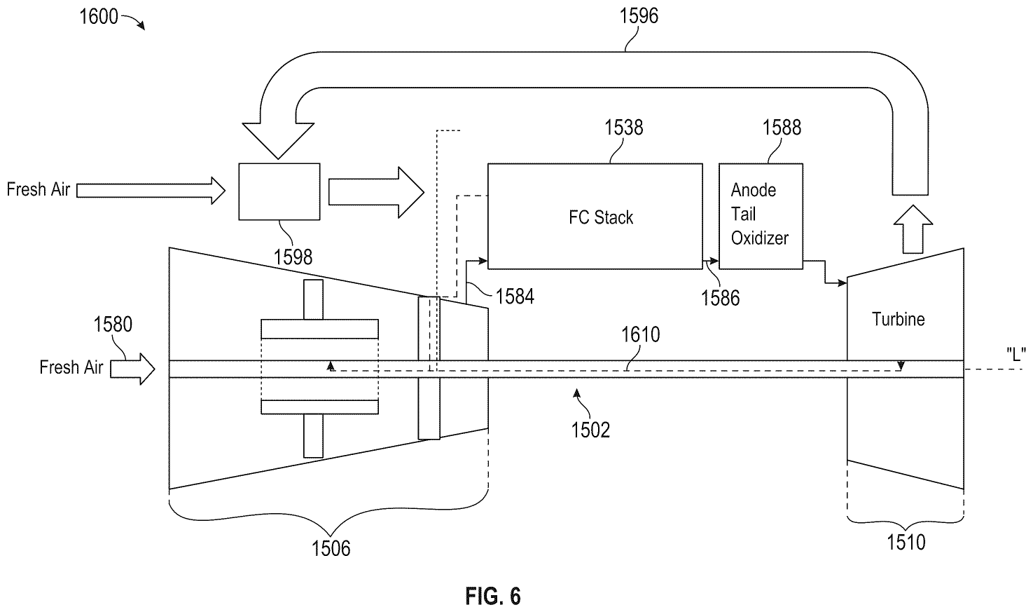

Referring to FIGS. 5 and 6, there is illustrated a further embodiment of our disclosure. As in the case of the FIGS. 3 and 4 embodiment, non-electrical common elements such as the propulsor have been omitted.

The embodiment shown in FIGS. 5 and 6 is similar to the embodiment shown in FIGS. 3 and 4 in many respects. However, in the embodiment shown in FIGS. 5 and 6, the central shaft is fixed, the electric motor stators are fixed to the shaft, the electric motor rotors and electric motor housings are configured to rotate around the electric motor stators, and the compressor rotors and the turbine rotors are configured to rotate with the electric motor rotors and housings.

Referring to FIGS. 5 and 6, there is shown an integrated hydrogen-electric turbomachine assembly 1500 that includes an elongated shaft 1502 that defines a longitudinal axis “L” and extends through the entire powertrain of integrated hydrogen-electric turbomachine assembly 1500 to function as a common shaft for the various components of the powertrain. Elongated shaft 1502 is fixed in place, and supports a plurality of electric motors 1505A, 1505B . . . within a multi-stage air compressor section 1506 which includes a plurality of compressor rotors 1508A, 1508B . . . and an electric motor 1505D within a turbine section 1510 comprising a turbine rotor 1512. Shaft 1502 is supported on compressor stators 1526A, 1526B . . . and turbine stator 1526D. Each electric motor 1505A, 1505B . . . 1505D includes a motor stator 1528A, 1528B . . . 1528D, which is fixed to shaft 1502, rotating motor rotors 1524A, 1524B . . . and 1524D, or rotating motor housing which act as the motor rotos. Compressor rotors 1508A, 1508B . . . and turbine rotor 1512 are supportedly fixed to rotating motor rotor/housings 1524A, 1524B . . . 1524D, respectively. Electric motor stators 1528A, 1528B . . . are fixed to shaft 1502 within the multi-stage air compressor section 1506, and an electric motor stator 1528D is fixed to shaft 1502 in turbine section 1510.

As in the case of the FIGS. 3-4 embodiment, compressor stators 1526A, 1526B . . . and turbine stator 1526D include internal passages (not shown) for carrying coolant air to and from the electric motors 1505A, 1505B . . . 1505D. The internal passages also may be configured to deliver lubricant to bearings (not shown). Also, as in the case of the FIGS. 3-4 embodiment compressor stators 1526A, 1526B . . . and turbine stator 1526D may be configured for accommodating electrical wiring for carrying electricity generated by FC stack 1538 on the exterior of housing 1525. Alternatively, compressor or turbine stators 1526A, 1526B . . . 1526D may be formed of electrically conductive materials for carrying electric current to the electric motors.

Also, as in the case of the earlier described embodiments FC stack 1538 may include heat exchanger inlet faces (not shown) and heat exchanger outlet faces (not shown) and are radially mounted to the exterior of housing 1525. Also, as in the case of the FIGS. 3-4 embodiment, an annular cathode manifold plenum (not shown) may be provided and configured to deliver compressed air from the air compressor section 1506 to the inlet faces of the FC stacks 1538.

Also, as in the case of the earlier described embodiments, the integrated hydrogen-electric turbomachine assembly 1500 includes inverters (not shown) located immediately to the outside of housing 1525 with the shortest path to each motor. The inverter(s) may include cooling fins (not shown) extending into housing 1525 in contact with the compressor airflow 1544. In similar manner as the earlier described embodiments, the electric motor stators 1528A, 1528B . . . 1528D may include cooling fin(s) (not shown), and the compressor airflow also may be used to cool the electric motors. The inverter(s) are configured to convert direct current from the FC stack 1538 to alternating current.

Referring in particular to FIG. 6, shaft 1502 may include passages 1610 within the shaft configured to convey fluids from one location along the shaft to another. Seals and rotating couplings (not shown) may be provided to enable multiple fluids to be conveyed to and from multiple locations. In particular, rotating seals may enable a coolant or lubricant to pass from the stationary shaft 1502 to the rotating motor rotors/shells 1508A, 1508B . . . 1512. In some cases, the fluids may be cryogenic coolants, including LH₂. This could enable superconducting motor windings. The turbine generator and compressor motors are electrically coupled, so that energy recovered from the turbine can be used to power the compressor. In one embodiment, electrical connections may be routed through the shaft 1502.

In operation, air is introduced into air inlet 1580 and compressed by the air compressor section 1506 and passed to the cathode side 1584 of FC stack 1538 where the oxygen in the air is reacted with hydrogen to produce electricity and reaction exhaust comprising primarily hot air and hot water. The water is separated, and the hot air exhaust from the FC stack 1538 is passed to the turbine section 1510 where it is used for driving the one or more turbine rotors 1512. Optionally, the hydrogen exhaust from the FC anode 1586 can be combined with the exhaust from the FC cathode 1584 and combusted in an anode tail oxidizer 1588, to harvest additional enthalpy to drive the turbine. Excess enthalpy in the flow after the turbine can be recycled via conduit 1596 to the FC stack 1538 where it is mixed with fresh cold air at 1598 to condition the ram air stream, or the warm air from the turbine may be employed to gasify LH₂ feed for the FCs.

Integrated hydrogen-electric turbomachine assembly 1500 further includes a controller 1600 for controlling the various aspects of the integrated hydrogen-electric turbomachine assembly 1500 and/or other components of the aircraft system. For example, controller 1600 can be configured to manage a flow of liquid hydrogen and coolant liquids, and rates of hydrogen and air to the FCs.

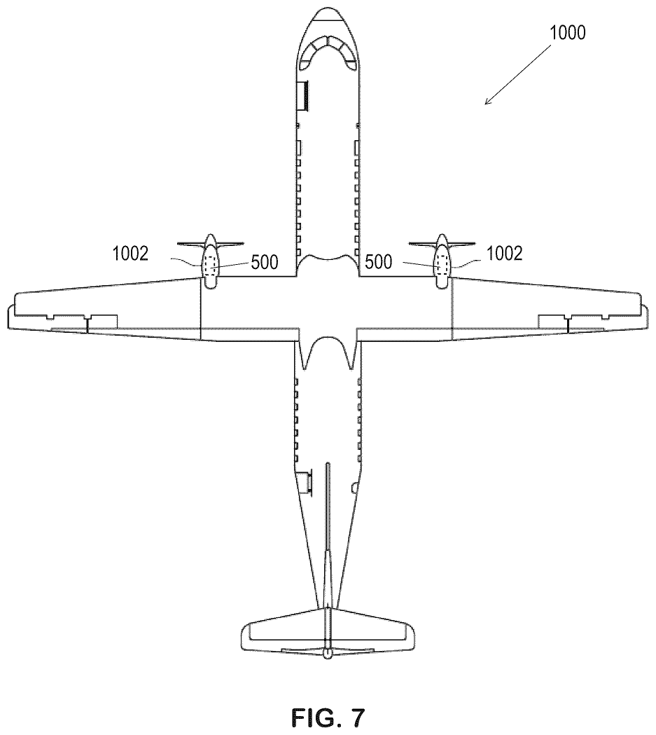

FIG. 7 illustrates an aircraft 1000 including a pair of hydrogen-electric turbomachine assembly 500 as above described in the wing nacelles 1002 of the aircraft.

A feature and advantage of the instant disclosure is that the housing, compressor stators, electric motor stator and turbine stators each serve multiple functions. This results in fewer components being needed, and a corresponding weight reduction. Also packaging the electric motor cores within the compressor section and turbine section permits us to provide an extremely compact hydrogen FC-powered electric engine system providing high power density, which may be sized and shaped to fit within the existing conventional aircraft wing nacelle.

The foregoing description of the embodiments has been provided for purposes of illustration and description. It is not intended to be exhaustive or to limit the disclosure. Individual elements or features of a particular embodiment are generally not limited to that embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure. Various changes and advantages may be made in the above disclosure without departing from the spirit and scope thereof.

### LIST OF REFERENCES

1 hydrogen-FC-electric engine system
12 air compressor system
12a inlet portion
12b compressor portion
14 propulsor
16 compressor wheels
17 waste gates
18 gearbox
19 radiators
20 fuel source
22 fuel pump
24 heat exchanger
26 FC stack
29 inverter
30 motor assembly
32 FC stack module
39 heater
100 hydrogen-electric turbomachine assembly
102 shaft
104 propulsor
106 multi-stage air compressor section
108A, 108B, 108C compressor rotors
110 turbine section
112 turbine rotor
125 housing
124A, 124B, 124C, 124D electric motor cores
126A, 126B, 126C air compressor stator
126C turbine stator
128A, 128B, 128C, 128D electric motor housing
129 cooling fins
130A, 130B, 130C, 130D bearing pairs
138 FC
140 inverter
144 airflow
160A, 160B, 160C, 160D internal passages
182 air outlet
184 cathode side
185 turbine inlet
186 FC anode
188 ATO
190 passages
200 controller
300 controller
500 hydrogen-electric turbomachine assembly
502 elongate shaft
505A, 505B, 505C, 505D electric motors
506 air compressor section
508A, 508B, 508C compressor rotors
508D turbine rotor
510 turbine section
512 turbine rotors
524A, 524B, 524C, 524D motor cores
525 housing
526A, 526B, 526C compressor stator
526D turbine stator
527 inlet faces
528A, 528B, 528C, 528D electric motor housing
529 outlet faces
530A, 530B, 530C, 530D bearing pairs
531 annular cathode manifold plenum
533 cooling fins
538 FC stack
544 airflow
560A, 560B, 560C, 560D internal passages
580 inverter
582 cooling fin
584 cathode side
585 turbine inlet
586 FC anode
587 nozzle
590 anode tail oxidizer
1000 aircraft
1002 nacelles
1500 hydrogen-electric turbomachine assembly
1502 shaft
1505A, 1505B, 1505C, 1505D electric motors
1506 air compressor section
1508A, 1508B compressor rotors
1510 turbine section
1512 turbine rotor
1524A, 1524B, 1524D motor rotors
1525 housing
1528A, 1528B, 1528C motor stator
1538 FC stack
1580 air inlet section
1584 cathode side
1586 FC anode
1588 anode tail oxidizer
1596 conduit
1598 mixed with fresh cold air
1600 controller

What is claimed:

1. An electrically-powered turbomachine assembly comprising:
a fixed housing;
an air compressor including one or more compressor rotors, and one or more compressor stators, where one or more of the compressor stators are fixed to the housing;
a turbine including one or more turbine rotors, and one or more turbine stators, where one or more of the turbine stators are fixed to the housing;
a central shaft supported at least in part by the one or more compressor stators and the one or more turbine stators; and
one or more electric motors including electric motor stators and electric motor rotors,
wherein the one or more electric motor stators are fixed to and arranged on a non-rotating shaft, and the air compressor and the turbine rotors are fixed to rotate with the electric motor rotors around the one or more electric motor stators.

2. The electrically-powered turbomachine assembly of claim 1, further comprising one or more fuel cells arranged on an outside of the housing.

3. The electrically-powered turbomachine assembly of claim 1, wherein the one or more electric motors are also configured to act as electrical generators.

4. The electrically-powered turbomachine assembly of claim 1, wherein the air compressor and the turbine respectively include one or more counter-rotating rotors.

5. The electrically-powered turbomachine assembly of claim 1, wherein the compressor rotors and the turbine rotors are configured independently change rotation direction or rotation speed.

6. The electrically-powered turbomachine assembly of claim 1, wherein one or more of the compressors are configured to function as turbines or one or more of the turbines are configured to function as compressors.

7. The electrically-powered turbomachine assembly of claim 1, wherein the central shaft does not include compressor stators or turbine stators.

8. The electrically-powered turbomachine assembly of claim 1, wherein the non-rotating shaft is configured as a conduit for fluid transfer and/or electrical power.

9. The electrically-powered turbomachine assembly of claim 1, wherein the one or more compressor stators are configured for carrying an electric current, and have a passage configured to accommodate an electrical conduit within the one or more stators, or are formed of an electrically conductive material configured to carry an electrical current.

10. The electrically-powered turbomachine assembly of claim 1, wherein the one or more compressor stators have a passage configured to carry a fluid, wherein the fluid optionally comprises a thermal transfer fluid for cooling the one or more motor stators and/or for cooling air as the air is moved through the air compressor, and optionally wherein the one or more compressor stators include internal fluidics channels configured to optimize heat exchange.

11. The electrically-powered turbomachine assembly of claim 2, wherein the one or more fuel cells comprise hydrogen fuel cells and the fluid comprises hydrogen and further wherein the shaft is configured to convey hydrogen in liquid form from one location along the shaft to another location and is configured to receive heat from the assembly to change the hydrogen from liquid form to gas form for use by one or more fuel cells.

12. The electrically-powered turbomachine assembly of claim 1, wherein the central shaft comprises a segmented shaft, wherein the shaft segments are mechanically coupled to one another.

13. The electrically-powered turbomachine assembly of claim 2, wherein one or more fuel cells are arranged radially on an outside of the housing, and wherein an output from the compressor optionally is coupled to an intake of the one or more fuel cells cathodes, wherein an exhaust from the one or more fuel cells optionally is coupled to an anode tail oxidizer, and wherein an inlet manifold for the turbine optionally is configured to contain a catalytic mesh for the anode tail oxidizer.

14. The electrically-powered turbomachine assembly of claim 2, wherein the fixed housing includes an annular manifold having an inlet configured to capture a flow of air from the air compressor, and wherein the annular manifold optionally has an outlet configured to deliver air to a cathode side of the one or more fuel cells.

15. The electrically-powered turbomachine assembly of claim 2, wherein an anode exhaust from the one or more fuel cells is passed to the turbine.

16. The electrically-powered turbomachine assembly of claim 1, wherein the one or more electric motors include fins configured to be cooled by airflow from the compressor.

17. A vehicle propulsion system utilizing the electrically-powered turbomachine assembly as claimed in claim 1 to provide thrust, electrical power and/or reactant conditioning.

18. The vehicle propulsion system of claim 17, wherein the electrically-powered turbomachine assembly includes one or more fuel cells as an electric power source.

19. The vehicle propulsion system of claim 18, wherein the vehicle comprises an airplane.
